(19) United States
(12) Patent Application Publication
(10) Pub. No.: US 2018/0072462 A1
(43) Pub. Date: Mar. 15, 2018

(54) EMESIS CONTAINER WITH INTEGRAL SPOUTS AND HANDLES

(71) Applicant: Aimee Schlueter, Batavia, IL (US)

(72) Inventor: Aimee Schlueter, Batavia, IL (US)

(21) Appl. No.: 15/264,030

(22) Filed: Sep. 13, 2016

(51) Int. Cl. B65D 25/42; A61J 19/00; B65D 43/02; B65D 25/28; B65F 1/02; B65F 1/16

(52) U.S. Cl. CPC B65D 25/42; A61J 19/00; B65D 43/0214; B65F 2240/172; B65F 1/02; B65F 1/16; B65D 25/28

(57) ABSTRACT

An emesis container that has two diametrically opposed pour spouts which are integral to the body of the container and form handles by which the user may grip the emesis container is disclosed. Further disclosed is the improvement of integrating recessed areas into the junction of the spouts and the body of the emesis container. An alternate embodiment with additional features encouraging children to use the emesis container as designed is also disclosed. A lid can be mechanically affixed to the container for secure storage of the contents.

This invention relates to a container of the type usually referred to as an emesis container, used primarily for receiving, containing, and disposing of biological wastes produced by regurgitation, vomiting, coughing, or excessive nasal/sinus discharge. The emesis container has integrated spouts which also form handles.

### BACKGROUND OF THE INVENTION

While the general use of containers to control and contain biological wastes expelled from the mouth and nose dates from time immemorial, containers specifically designed for this purpose and/or to encourage and ease the use of such containers are useful and highly desirable.

Many such containers have been marketed. These range from the classic “emesis basin,” or “kidney dish,” (see: https://en.wikipedia.org/wiki/Kidney_dish) to special purpose containers or containment systems such as that disclosed by U.S. Design Pat. No. D612,181 (Tanguay) or U.S. Pat. No. 9,044,363 (Tanguay). However, for any given patient and/or clinical situation, any particular emesis container may not be the optimal solution. Novel emesis containers which are economical, styled appropriately for a particular patient demographic, and simple to use and maintain are always desirable to maximize clinical benefits, hygiene, and patient outcomes. The present invention addresses these concerns.

Furthermore, there is a non-clinical need for emesis containers. Emesis containers are useful at home and in automobiles and other modes of transportation. All demographics can utilize emesis containers. One particular demographic is children. When children are sick at home, they may not be able to reach a sink, garbage can, toilet, or other receptacle in a timely manner. Or, when children are in an automobile or other transportation vehicle, they may get motion sickness or general illness. In this situation, there may not be an appropriate receptacle to catch emesis or other bodily fluids. The present invention addresses these concerns.

### SUMMARY OF THE INVENTION

Among the many objectives of the present invention is the provision of an emesis container which has integrated spouts for efficient and hygienic emptying of the container.

Another objective of the present invention is the provision of an emesis container which has integrated handles to allow the safe and secure handling of the container by a person who is vomiting.

Yet another objective of the present invention is the provision of an emesis container in which the integrated spouts and integrated handles are part of the same elements of the container.

Still another objective of the present invention is the provision of an emesis container which is easy for a child or other user with limited dexterity or strength to use.

These and other objectives of the invention (which other objectives become clear by consideration of the specification, claims, and drawings as a whole) are met by providing an emesis container with integrated spouts and handles meant to be gripped by a person with limited strength or dexterity.

### BRIEF DESCRIPTION OF THE DRAWINGS

FIG. 1 depicts a front plan view of an emesis container 10 with integrated spouts and handles 12.

FIG. 2 depicts a side plan view of an emesis container 10 with integrated spouts and handles 12.

FIG. 3 depicts a top plan view of an emesis container 10 with integrated spouts and handles 12.

FIG. 4 depicts a front plan view of an emesis container 10 with integrated spouts and handles 12 with integrated grips 40a and 40b.

FIG. 5 depicts a side plan view of an emesis container 10 with integrated spouts and handles 12 with integrated grips 40a and 40c.

FIG. 6 depicts a top plan view of an emesis container 10 with integrated spouts and handles 12 with integrated grips 40a, 40b, 40c, and 40d.

FIG. 7 depicts a front, top perspective view of an emesis container 10 with integrated spouts and handles 12 and with a lid 70.

Throughout the figures of the drawings, where the same part appears in more than one figure of the drawings, the same number is applied thereto.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the invention in any manner.

The terms “vomit” and “vomiting” will be used throughout the description of the preferred embodiment(s). These terms should be taken to include the results of and the acts of vomiting, regurgitation, expectoration, and any other act of expelling vomitus, mucus, phlegm, fluids, wastes, or other materials (herein collectively, “waste”), from the mouth and/or nose. The invention may also be used to capture and contain other biological wastes, such as feces or urine, though this is not preferred.

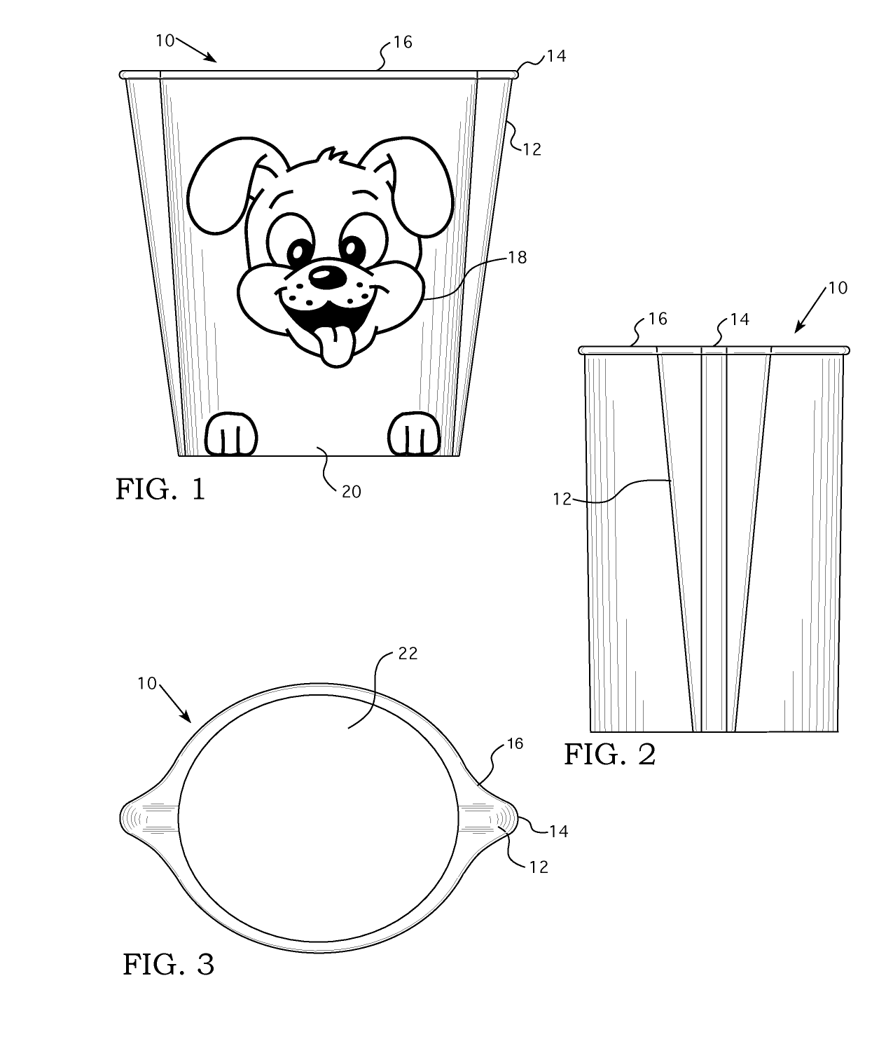

Now adding FIG. 1 to the consideration, the structure and function of the basic embodiment can be clearly understood. Emesis container 10 comprises a central containment area 20 or “body,” into which spouts 12 have been molded or formed during or after initial manufacture. It is preferred, but not required, that emesis container 10 have a non-uniform horizontal cross-section such that the bottom of the container is smaller than the top. This makes container 10 easier to hold. If container 10 will be used in an environment where tipping is a particular problem (e.g. on a seagoing vessel), it may be more preferred to reverse this such that the bottom is larger than the top to increase stability.

Spouts 12 form natural handles which make it easier to orient and hold on to emesis container 10. Spouts 12 have pouring apexes 14 (see FIGS. 2 and 3) which allow container 10 to be emptied neatly and efficiently by tipping it in the direction of either spout 12. Rolled lip 16 goes around the circumference of the top of emesis container 10, and both reinforces it and provides an additional element to make holding on to container 10 easier. Decoration 18, which is not required, makes container 10 more visually appealing and comforting to youthful users. If primarily meant for use by children, container 10 can be sized appropriately for small hands, but even at a size suitable for most users, the features of the invention will increase the utility of emesis containers 10 for all users when applied.

Now adding FIG. 2 to the consideration, an alternate perspective on emesis container 10 is provided. As can be seen, it is strongly preferred that spouts 12 project from emesis container 10 along its entire vertical length. This maximizes their utility as handles and allows the user to quickly orient container 10 no matter where on its vertical length their hands happen to make contact when container 10 is picked up. It is strongly preferred that spouts 12 have an upper termination which is in the same horizontal plane as opening 22 of emesis container 10 generally, so that they maximize waste retention while allowing quick and efficient emptying of container 10. However, spouts 12 can project from container 10 for anywhere from at least fifty percent to the entire vertical length of container 10.

Now adding FIG. 3 to the consideration, the geometry of spouts 12 relative to the rest of emesis container 10 is disclosed. It is strongly preferred, but not required, that main body 20 of emesis container 10 be symmetrically elongated on the axis defined by pouring apexes 14. This causes waste to flow naturally toward pouring apexes 14 when container 10 is tipped in the direction of spouts 12 and makes it easier and more natural to appropriately orient container 10 when emptied. It also encourages the user to hold container 10 in the most appropriate orientation. It is required that the elongation not be so pronounced as to make it difficult for the user to orient their mouth to opening 22 or to make it probable that waste will overshoot or undershoot the areas of opening 22 which are nearest to and/or farthest away from the user.

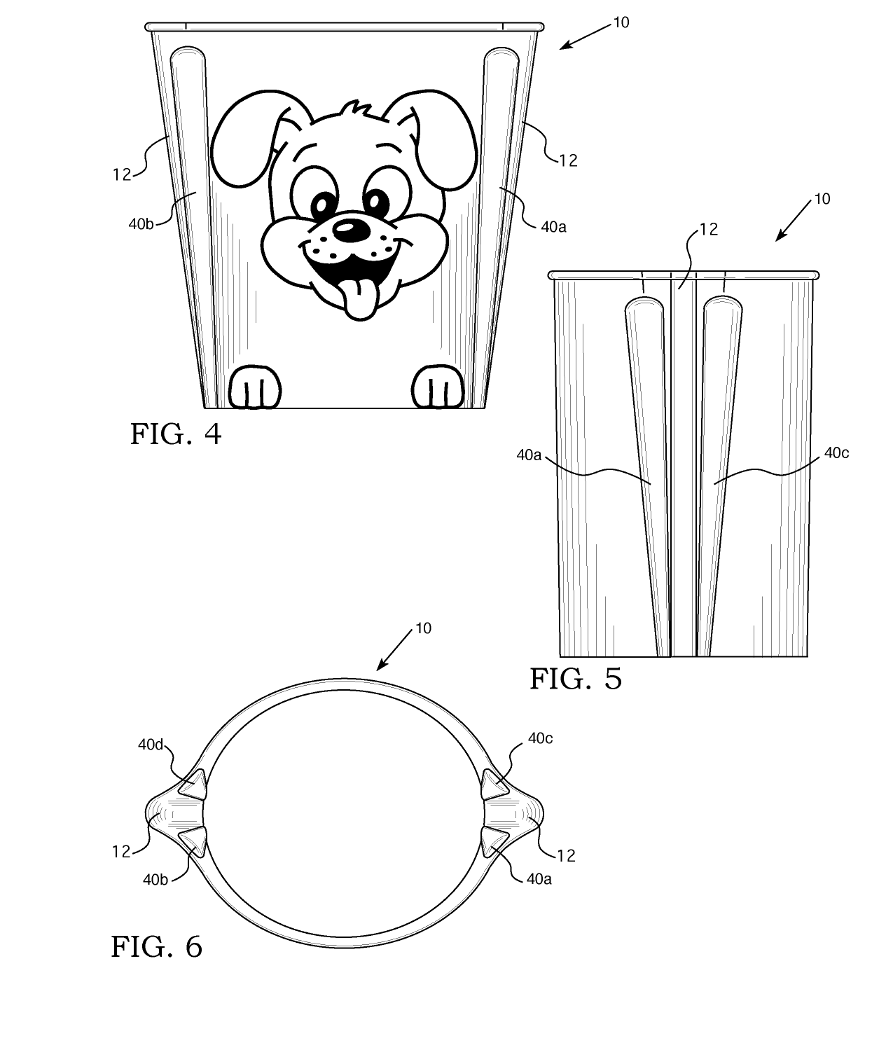

Now adding FIG. 4, FIG. 5, and FIG. 6 to the consideration, the preferred embodiment is disclosed. Integrated grips 40a and 40c on the right side and integrated grips 40b and 40d on the left side have been added to spouts 12, or as is most preferred, into the area where spouts 12 join body 20 of emesis container 10. The user's fingers and thumbs will naturally enter into the depressed areas of integrated grips 40a, 40b, 40c, and 40d. This will create a more robust grip on container 10. It is strongly preferred, but not required, that the depressed areas of integrated grips 40a, 40b, 40c, and 40d have a termination below the horizontal plane defined by the top of emesis container 10. This will result, if configured as shown, in a natural “stop” which will give the user's uppermost finger, or their thumb, something to brace against and increase the stability of their grip. It will also help them locate their hands quickly and easily when picking up container 10, since it is preferred to hold container 10 near, but not at the top, to maximize control and stability while minimizing the chances of getting waste on the user's hands. When emptying container 10, use of integrated grips 40a and 40c (or vice versa) to hold container 10 while tipping in the direction of opposing spout 12 will maximize grip stability as well.

Now referring to FIG. 5 and FIG. 6, the configuration of gripping surfaces on either side of container 10 is disclosed. If the user were to hold container 10 such that their right hand was gripping the side visible, their fingers will enter integrated grip 40c while their thumb will enter integrated grip 40a. Their index finger and their thumb will be braced against the uppermost area of the respective grips 40a and 40c such that container 10 will be unlikely to slip downward and out of their grip, and the user's thumb and index finger will be prevented from reaching or even crossing opening 22 of container 10 and being exposed to wastes. It is strongly preferred, but not required, that spout 12 integrate both integrated grip 40a and 40c. If container 10 integrates only one, it is preferred, but not required, that container 10 integrate integrated grip 40c such that the fingertips enter integrated grip 40c and the thumb can be braced against spout 12. The reverse is true for the reverse side of container 10 and integrated grips 40b and 40d.

Now referring to FIG. 6, the configuration of all integrated grips can be seen. Each spout 12 has two integrated grips, one on either side, preferably in the areas where spout 12 joins body 20 of container 10. This produces the optimal configuration of the user's hands, allowing them to quickly and easily orient container 10 for maximum usefulness even if distressed or distracted by illness or discomfort. This configuration also makes it easier for visually impaired persons to quickly and correctly orient container 10.

The remaining figures disclose additional information useful to those of reasonable skill in the relevant art and allow them to practice the invention, including an alternate embodiment, with reasonable effort.

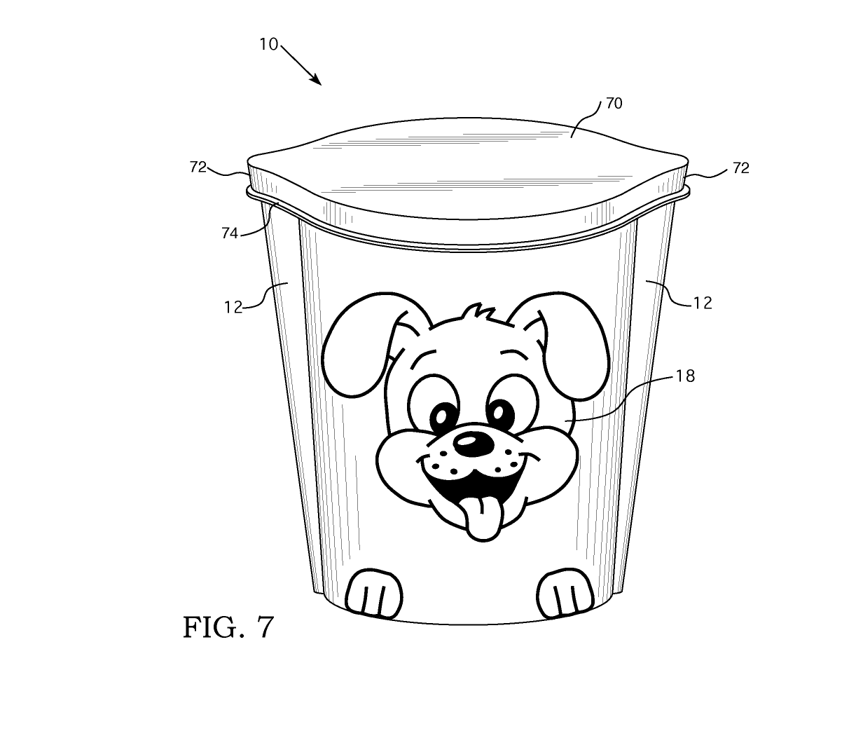

Now adding FIG. 7 to the consideration, lid 70 has been added. This is an optional enhancement to the preferred embodiment which increases the hygienic security of container 10. Sidewall 72 extends downward to form an additional interfacing surface with body 20 of container 10. It is preferred to add lid reinforcing lip 74, which makes sidewall 72 stronger and more tolerant of repeated application/removal cycles by adding reinforcing mass to the bottom of sidewall 72. Lid reinforcing lip 74 may be a separate component added to lid 70 during or after manufacture, or it may simply be a slightly increased volume of material created by the molding or manufacturing of lid 70.

It is preferred, but not required, for body 20 of container 10 to taper negatively on the vertical axis: the top of container 10 is preferred to be somewhat larger in the horizontal plane than the bottom. If this is done, it is strongly preferred that sidewall 72 have a congruent taper, which will allow it to remain attached mechanically and provide a better seal between container 10 and lid 70. If the taper of sidewall 72 is such that the diameter of the bottom of sidewall 72 and/or lid reinforcing lip 74 is smaller than the diameter of the opening of container 10, it is required that sidewall 72 and/or lid reinforcing lip 74 have sufficient elasticity to allow sidewall 72 and/or lid reinforcing lip 74 to be pulled over the opening of container 10. It is required that sidewall 72 not have a taper which is so much greater than the body of container 10 as to prevent lid 70 from being applied to container 10.

As an alternative to the configuration discussed in the previous paragraph, lid 70 may simply snap over or otherwise engage rolled lip 16 or some other boss, member, or extrusion of body 20 of container 10 which is at or near opening 22 in body 20 of container 10. Although it is preferred that some positive engaging means be used, lid 70 may simply engage by friction if it is appropriately sized. It is preferred, but not required, that such engagement be along the entire circumference of opening 22 to minimize the possibility of leaks and to retain any odors which may be present due to the waste.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this emesis container can become clear to a person having ordinary skill in this particular art. Modifications or alternate embodiments which might be practiced, whether or not claimed below, include but are not limited to:
1) The container can be made of any desired and appropriate material, including either metal (e.g. stainless steel), thermoplastic, or disposable resin or pulp, depending on the intended use, environment, and economic value.
2) The container can have an integrated hook or other hanging/support member to allow it to hang on a bedrail or other convenient place, or a separate mountable receiving element into which it could be placed when not in use.
3) The container can be made of a material with antimicrobial properties or coated with such a material (e.g. the family of materials and additives/coatings sold under the trade name “Microban®” by Microban International, Ltd.).
4) The surfaces of the integrated grips, and/or any other desired portion of the emesis container, can be formed with a non-slip texture and/or covered with a non-slip material.
5) The bottom of the emesis container can be weighted so as to make it less likely to tip over while in use. It can even be magnetized to allow maximum stability on an appropriate surface.

Such modifications are clearly covered by this disclosure.

What is claimed and sought to be protected by Letters Patent is:

1. An emesis container comprising:
a) a container having a body with an open top and a closed bottom;
b) a first spout which projects from the body of the container and is open to the body; and,
c) a second spout which projects from the body of the container in a position diametrically opposed to the first spout and is likewise open to the body, such that the body of the container, the first spout, and the second spout comprise a single vessel which allows a liquid to enter or exit only through the open top.

2. The emesis container of claim 1 wherein the body of the container has a vertical length, and the first spout and the second spout project from the body of the container for its entire vertical length.

3. The emesis container of claim 1 wherein the body of the container has a horizontal cross section having a first axis which is defined by a first line connecting the first spout and the second spout, and a second axis which is defined by a second line orthogonal to the first line, and a first diameter of the body of the container on the first axis is larger than a second diameter of the body of the container on the second axis.

4. The emesis container of claim 2 wherein the body of the container has a horizontal cross section having a first axis which is defined by a first line connecting the first spout and the second spout, and a second axis which is defined by a second line orthogonal to the first line, and a first diameter of the body of the container on the first axis is larger than a second diameter of the body of the container on the second axis.

5. The emesis container of claim 1 wherein the body of the container has a vertical length, and the first spout and the second spout project from the body of the container for fifty percent or more of the vertical length of the body.

6. The emesis container of claim 3 wherein the body of the container has a vertical length, and the first spout and the second spout project from the body of the container for fifty percent or more of the vertical length of the body.

7. An emesis container comprising:
a) a container having a body with an open top and a closed bottom;
b) a first spout which projects from the body of the container and is open to the body;
c) a second spout which projects from the body of the container in a position diametrically opposed to the first spout and is likewise open to the body, such that the body of the container, the first spout, and the second spout comprise a single vessel which allows a liquid to enter or exit only through the open top; and,
d) at least two integrated grips, each of the at least two integrated grips formed by indenting a portion of the body of the container along a vertical intersection of the body of the container with the first spout or the second spout.

8. The emesis container of claim 7 wherein the body of the container has a horizontal cross section having a first axis which is defined by a first line connecting the first spout and the second spout, and a second axis which is defined by a second line orthogonal to the first line, and a first diameter of the body of the container on the first axis is larger than a second diameter of the body of the container on the second axis.

9. The emesis container of claim 7 wherein the body of the container has a vertical length, and the first spout and the second spout project from the body of the container for its entire vertical length.

10. The emesis container of claim 8 wherein the body of the container has a vertical length, and the first spout and the second spout project from the body of the container for its entire vertical length.

11. The emesis container of claim 7 wherein the body of the container has a vertical length, and the first spout and the second spout project from the body of the container for fifty percent or more of the vertical length of the body.

12. The emesis container of claim 8 wherein the body of the container has a vertical length, and the first spout and the second spout project from the body of the container for fifty percent or more of the vertical length of the body.

13. The emesis container of claim 1 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

14. The emesis container of claim 2 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

15. The emesis container of claim 3 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

16. The emesis container of claim 4 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

17. The emesis container of claim 5 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

18. The emesis container of claim 6 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

19. The emesis container of claim 7 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

20. The emesis container of claim 8 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

21. The emesis container of claim 9 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

22. The emesis container of claim 10 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

23. The emesis container of claim 11 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.

24. The emesis container of claim 12 wherein a lid may be mechanically affixed to the container, the lid comprising:
a) a horizontal element of the lid having an area larger than and roughly congruent to the open top; and,
b) a sidewall element of the lid, the sidewall element descending vertically from the perimeter of the horizontal element such that when the horizontal element of the lid is tangential to the open top, the sidewall element of the lid is tangential to an adjacent portion of the body of the container.
